(19) United States
(12) Patent Application Publication
(10) Pub. No.: US 2007/0108895 A1
(43) Pub. Date: May 17, 2007

(54) Electroluminescent device

(75) Inventors: Yasuyuki Goto, Fukuoka-shi (JP); Mitsuharu Noto, Kurume-shi (JP); Masanao Era, Saga-shi (JP)

Correspondence Address: DARBY & DARBY P.C., P. O. BOX 5257, NEW YORK, NY, 10150-5257, US

(73) Assignees: Kyushu Electric Power Co., Inc., Fukuoka-shi (JP); Daiden Co., Ltd., Kurume-shi (JP)

(21) Appl. No.: 10/563,168

(22) PCT Filed: Jun. 23, 2004
(86) PCT No.: PCT/JP04/08799

§ 371 Date: Dec. 29, 2005

(30) Foreign Application Priority Data
Jun. 30, 2003 (JP) 2003-188158

(51) Int. Cl. H05B 33/00

(52) U.S. Cl. 313/506; 313/504

(57) ABSTRACT

An electroluminescence device is provided which undergoes luminescence by recombination of a hole to be injected from an anode and an electron to be injected from a cathode and is provided with a luminescent layer formed of an inorganic compound between a hole transport layer and an electron transport layer each formed of an organic compound. As the inorganic compound, for example, a combination of europium(II) bromide with cesium iodide can be used.

### TECHNICAL FIELD

The present invention relates to a novel charge injection type electroluminescence device.

In more detail, the invention relates to a novel charge injection type electroluminescence device which in addition to use of a phosphorescent material as a luminescent layer, can be expected to improve a luminous efficiency by enhancing an internal quantum efficiency.

Also, the invention relates to an electroluminescence device having good color purity and especially suitable in the blue color for full color display.

### BACKGROUND ART

Hitherto, as thin type electroluminescence devices, an inorganic electroluminescence device using an inorganic compound in the luminescent layer has been the main current.

The inorganic electroluminescence device employs a system in which an inorganic compound is sandwiched by insulating layers and which is driven by application of an alternating current voltage and is a genuine electroluminescence device in which a high-speed electron as accelerated in the high electric field collides with a luminescence center to excite it. The inorganic electroluminescence device is put into practical use in displays of car audio or FA (Factory Automation) instruments and the like because of its high durability.

However, the conventional inorganic electroluminescence devices involve such problems that an alternating current supply and a voltage as high as 200 V are required for their driving; that they are difficult for realization of full colorization; and that they are not satisfied with respect to luminance.

On the other hand, in 1987, Messrs. C. W. Tang, et al. of Eastman Kodak Company reported an organic electroluminescence device composed of an organic thin film laminated between an anode and a cathode and realized high luminance by low-voltage driving (see Non-Patent Document 1).

Non-Patent Document 1: C. W. Tang, et al., Applied Physics Letters, 1987. vol. 51, p. 913

This device is also called as an “electron injection type”, and with respect to its luminescence mechanism, it is said that a hole as injected from an anode and an electron as injected from a cathode are recombined with each other to form a molecule in the excited state (hereinafter referred to as “exciton”) and that during return of the exciton to the ground state, it releases energy to cause luminescence.

Since this report by Messrs. C. W. Tang, et al., with respect to the organic electroluminescence devices, studies regarding luminescence of three primary colors of RGB, luminance improvement, stability, lamination structure, preparation method, and so on have eagerly been carried out. At the present time, the organic electroluminescence devices have begun to be partly put into practical use as a display for mobile phone or car audio and are promising as a flat display of the next generation as a replacement of liquid crystal display.

Now, the luminescence as seen in the organic electroluminescence device is a luminescence phenomenon when an exciton returns to the ground state as described previously. Then, the kind of an exciton which an organic compound forms includes the singlet excited state and the triplet excited state. Also, it is theoretically (statistically) known that a formation ratio of excitons in the singlet excited state and triplet excited state in the organic electroluminescence device is 1/3.

Further, the ground state of an organic compound is usually the singlet ground state. Also, the transition of from the singlet excited state to the singlet ground state is the spin tolerance transition (the spin directions are opposite), while the transition of the triplet excited state to the singlet ground state is the spin inhibition transition of intensity (the spin directions are the same).

In the light of the above, even if an exciton in the triplet excited state tries to return to the singlet ground state, since electrons which spin in the same direction are already present in the ground state, the exciton in the triplet excited state remains in the excited state long and releases energy as heat, and as a result, it cannot contribute to the luminescence.

For this reason, in general organic compounds, only luminescence (fluorescence) from the singlet excited state is usually observed, but luminescence (phosphorescence) from the triplet excited state is not observed. Moreover, as described previously, since the formation ratio of excitons in the singlet excited state and the triplet excited state is 1/3, it is considered that the upper limit of an internal quantum efficiency of the luminescence in an organic electroluminescence device is 25%. Namely, even if one hundred electrons are recombined with holes to generate energy excitation, theoretically, only twenty-five photons are produced from the one hundred electrons, and the productivity is extremely low.

Then, in recent years, for the purpose of enhancing an internal quantum efficiency, an organic compound which causes luminescence (phosphorescence) utilizing an exciton in the triplet excited state has begun to be developed.

On the other hand, in order to put flat displays of television sets, computers, etc. into practical use, not only an improvement of the foregoing luminous efficiency but also full colorization is necessary and essential. Especially, as the blue color for full color display, since its chromaticity is shifted to the green side, the development of a blue luminescent layer having good color purity is desired.

For the purpose of solving this problem regarding the color purity, for example, one in which a distyryl-arylene derivatives is used as a luminescent layer and a fluorescent dopant (DSA amine which is an amine derivative) is introduced into this luminescent layer is developed, and it is reported that blue luminescence of the CIE 1931 chromaticity coordinates (0.15, 0.16) was obtained (see Non-Patent Document 2).

Non-Patent Document 2: Chishio HOSOKAWA and Tadashi KUSUMOTO (supervised by Junji KIDO), Yuki EL Zairyo to Dhisupurei (Organic Electroluminescence Materials and Displays), 2001, p. 321

### DISCLOSURE OF THE INVENTION

### Problems that the Invention is to Solve

As described previously, in a charge injection type electroluminescence device, for the purpose of improving a luminous efficiency by enhancing an internal quantum efficiency, an organic compound which undergoes luminescence (phosphorescence) by utilizing an exciton in the triplet excited state has begun to be developed.

However, it is the present state that materials which stably emit phosphorescence at room temperature are very few as compared with fluorescent materials and that the degree of freedom in material selection is narrow. For this reason, the development of a novel charge injection type electroluminescence device which in addition to use of a phosphorescent material as a luminescent layer, can be expected to improve a luminous efficiency by enhancing an internal quantum efficiency is desired.

Also, as described previously, though as a blue luminescent layer having good color purity, one having realized the CIE 1931 chromaticity coordinates (0.15, 0.16) has been reported, if a blue luminescence material having higher color purity is realized, use of a color filter becomes unnecessary, and displays having higher quality can be realized.

Then, the present inventors made extensive and intensive investigations on the basis of ideas regarding whether or not in addition to use of a phosphorescent material as a luminescent layer, any measure for enhancing an internal quantum efficiency is available and as a result, have completed a novel charge injection type electroluminescence device in which a luminescent layer is formed of only an inorganic compound.

Namely, in view of the matter that the internal quantum efficiency “25%” of conventional electroluminescence devices is caused due to the formation ratio (1/3) of excitons in the singlet excited state and the triplet excited state, if an inorganic compound which is not influenced by this formation ratio of excitons is used in a luminescent layer, it can be expected to increase the luminous efficiency by enhancing an internal quantum efficiency.

Moreover, if a luminescent layer is formed of an inorganic compound, the results of useful studies regarding inorganic electroluminescence devices which have hitherto been accumulated (e.g., what luminescence characteristics are obtained when what kind of inorganic compound is used in the luminescent layer) can be made by reference, and the degree of freedom in selection of a luminescence material is spread.

### OBJECT OF THE INVENTION

An object of the invention is to provide a novel charge injection type electroluminescence device which in addition to use of a phosphorescent material as a luminescent layer, can be expected to improve a luminous efficiency by enhancing an internal quantum efficiency.

Another object of the invention is to provide an electroluminescence device having good color purity and especially suitable in the blue color for full color display.

### MEANS FOR SOLVING THE PROBLEMS

Specifically, the means of the invention which have been taken for the purpose of achieving the foregoing objects are as follows.

A first invention is concerned with a charge injection type electroluminescence device for undergoing luminescence by recombination of a hole to be injected from an anode and an electron to be injected from a cathode, which is characterized in that a luminescent layer formed of an inorganic compound is provided between a hole transport layer and an electron transport layer each formed of an organic compound.

A second invention is concerned with the electroluminescence device according to the first invention, which is characterized in that the inorganic compound is provided with a metal compound which undergoes luminescence by luminescent transition by spin tolerance transition or spin inhibition transition, or undergoes luminescence by luminescent transition by inner-shell transition of a metal ion.

A third invention is concerned with the electroluminescence device according to the first or second invention, which is characterized in that the inorganic compound is a combination of a luminescent metal compound with an inorganic compound capable dissolving the metal compound therein as a solid solution.

A fourth invention is concerned with the electroluminescence device according to the first, second or third invention, which is characterized in that the inorganic compound is a metal halide.

A fifth invention is concerned with the electroluminescence device according to the first, second or third invention, which is characterized in that the inorganic compound is a combination of a halide of a rare earth element with a halide of an alkali metal or alkaline earth metal.

A sixth invention is concerned with the electroluminescence device according to the first, second or third invention, which is characterized in that the inorganic compound is a combination of a halide of divalent europium with a halide of an alkali metal or alkaline earth metal.

A seventh invention is concerned with the electroluminescence device according to the first, second or third invention, which is characterized in that the inorganic compound is a combination of europium(II) bromide with cesium iodide.

### ADVANTAGE OF THE INVENTION

Advantages of the invention are as follows.

(a) According to the invention, different from an organic electroluminescence device using an organic compound as a luminescent layer, by using a luminescent layer formed of only an inorganic compound between a hole transport layer and an electron transport layer each formed of an organic compound, a novel charge injection type electroluminescence device which is not influenced by a critical value of an internal quantum efficiency which is considered to be 25% as its upper limit can be formed. In this way, by enhancing the internal quantum efficiency, a novel charge injection type electroluminescence device which can be expected to improve a luminous efficiency can be obtained.

(b) When a combination of a luminescent metal compound with an inorganic compound capable dissolving the metal compound therein as a solid solution is used as the inorganic compound, it is possible to suppress concentration quenching by making a distance between metal ions regarding the luminescence far. As a result, it is possible to enhance a luminous efficiency of the electroluminescence device.

(c) When a metal halide is used as the inorganic compound, since the luminescent layer can be subjected to vapor deposition at a relatively low temperature, there is an advantage that the organic layer is hardly injured by heat.

(d) When a combination of europium(II) bromide with cesium iodide is used as the inorganic compound, it is possible to form a blue luminescence device having high color purity exceeding the CIE 1931 chromaticity coordinates (0.15, 0.16) of the luminescence device as described in Non-Patent Document 2.

### BRIEF DESCRIPTION OF THE DRAWINGS

FIG. 1 is an explanatory view to show the device construction of an electroluminescence device according to Example 1 of the invention.

FIG. 2 is a characteristic graph of emission spectra of electroluminescence devices according to Examples 1 to 4.

FIG. 3 is a characteristic graph to show the relationship of luminance-electric current of the electroluminescence device according to Example 1.

FIG. 4 is a characteristic graph of emission spectra of electroluminescence devices according to Example 1 and Example 5.

FIG. 5 is a characteristic graph to show the relationship of luminance-electric current of the electroluminescence devices according to Example 1 and Example 5.

FIG. 6 is a characteristic graph of emission spectra of electroluminescence devices according to Example 1 and Example 6.

FIG. 7 is a characteristic graph to show the relationship of luminance-electric current of the electroluminescence devices according to Example 1 and Example 6.

FIG. 8 is a characteristic graph to show the relationship of luminance-voltage of the electroluminescence devices according to Example 1 and Example 6.

### DESCRIPTION OF REFERENCE NUMERALS AND SIGNS

1: Electroluminescence device
2: Transparent electrode
3: Glass substrate
4: Hole transport layer
5: Luminescent layer
6: Hole block layer
7: Electron transport layer
8: Cathode
9: Electrode

### BEST MODE FOR CARRYING OUT THE INVENTION

The electroluminescence device according to the invention is, for example, formed by the following constructions. Examples include:

(1) A construction formed by successively laminating a substrate, an anode (transparent electrode), a luminescent layer formed of only an inorganic compound, and a cathode (back electrode);

(2) A construction formed by successively laminating a substrate, an anode, a luminescent layer formed of only an inorganic compound, a single organic material layer or plural organic material layers having electron transport properties, and a cathode;

(3) A construction formed by successively laminating a substrate, an anode, a single organic material layer or plural organic material layers having hole transport properties, a luminescent layer formed of only an inorganic compound, and a cathode; and

(4) A construction formed by successively laminating a substrate, an anode, a single organic material layer or plural organic material layers having hole transport properties, a luminescent layer formed of only an inorganic compound, a single organic material layer or plural organic material layers having electron transport properties, and a cathode.

Also, a construction having a hole block layer or an electron injection layer can be used.

Examples of the substrate include glasses, plastics, and metallic thin films. However, it should not be construed that the invention is limited thereto.

Examples of the anode (transparent electrode) include ones prepared by forming indium-tin-oxide (ITO), titanium oxide, tin oxide, or the like into a thin film by the vacuum vapor deposition method, the sputtering method, or the sol-gel method. However, it should not be construed that the invention is limited thereto.

Examples of the organic material layer having hole transport properties include polyvinylcarbazole (PVK), phenylenediamine derivatives (for example, N,N′-bis(3-methyl-phenyl)-N,N′-bis(phenyl)-benzidine (TPD)), triphenylamine derivatives, carbazole derivatives, and phenylstyrene derivatives. However, it should not be construed that the invention is limited thereto.

Examples of the organic material layer having electron transport properties include oxadiazole derivatives, tri-azole derivatives, phenanthroline derivatives, and aluminum-quinolinol complexes. However, it should not be construed that the invention is limited thereto.

The organic material layer having hole transport properties and the organic material layer having electron transport properties can be formed by the vacuum vapor deposition method, the spin coating method, or the like.

Examples of the cathode (back electrode) include lithium, aluminum, magnesium, and silver. However, it should not be construed that the invention is limited thereto.

The luminescent layer formed only of an inorganic compound can be formed by, for example, the vacuum vapor deposition method or the spin coating method. However, it should not be construed that the invention is limited thereto.

Incidentally, the vacuum vapor deposition method is preferable because a uniform film is likely obtained, and a pin hole is hardly formed.

Also, the inorganic compound is preferably a combination of a luminescent metal compound with an inorganic compound capable dissolving the metal compound therein as a solid solution.

By dissolving the metal compound therein as a solid solution, it is possible to suppress concentration quenching by making a distance between metal ions regarding the luminescence far. As a result, it is possible to enhance a luminous efficiency of the electroluminescence device.

As the inorganic compound, a metal halide which can be subjected to vapor deposition at a relatively low temperature so as to not injure the organic layer by heat is preferable.

Examples of the inorganic compound include a halide of a rare earth element and a halide of an alkali metal or alkaline earth metal as described later and besides, luminescent metal compounds using manganese, copper, antimony, platinum, silver, gold, mercury, molybdenum, tungsten, iridium, ruthenium, cobalt, etc.

Incidentally, the inorganic compound can be formed singly or in combinations of two or more kinds thereof into a luminescent layer.

Examples of the halide include fluorides, chlorides, bromides, and iodides.

More specifically, examples of the metal halide include combinations of a halide of a rare earth element with a halide of an alkali metal or alkaline earth metal.

Examples of the rare earth element include cerium, praseodymium, neodymium, samarium, europium, gadolinium, terbium, dysprosium, holmium, erbium, thulium, and ytterbium.

Examples of the alkali metal include lithium, sodium, potassium, rubidium, and cesium.

Examples of the alkaline earth metal include magnesium, calcium, strontium, and barium.

Incidentally, the halide of an alkali metal or alkaline earth metal can be formed singly or in combinations of two or more kinds thereof into a luminescent layer.

For example, in the case where a metal compound having divalent europium is used as the inorganic compound, the luminescence of EU²⁺ is derived from the inner-shell transition of a europium ion of from the lowest excited state (4f)⁶(5d)¹ to the ground state (4f)⁷ as luminescent transition. The (4f)⁷ level of Eu²⁺ (ground state) is the spin octet; and the (4f)⁶(5d)¹ level of Eu²⁺ (lowest excited state) is a mixture of the spin octet and sextet. In the luminescence from these respective excited states, the transition of from the octet excited state to the octet ground state is the spin tolerance transition; and the transition of from the sextet excited state to the octet ground state is the spin inhibition transition. Moreover, different from the luminescent layer of the organic electroluminescence device, it is said that Eu²⁺ undergoes luminescence from both the spin tolerance transition and the spin inhibition transition.

Accordingly, if this Eu²⁺ is utilized as the luminescent layer of the charge injection type electroluminescence devices, as compared with organic electroluminescence devices in which the internal quantum efficiency “25%” is usually considered as an upper limit, a luminous efficiency of 100% of the internal quantum efficiency which is four times of the former can be expected.

The terms “spin tolerance transition or spin inhibition transition” as referred to in this specification mean the case including either one of the spin tolerance transition or the spin inhibition transition in some case, or mean the case including both the spin tolerance transition and the spin inhibition transition in some case.

Also, in the case where a metal compound containing cerium is, for example, used as the inorganic compound, the excited state of a cerium ion is the (5d)¹ level, and the ground state thereof is the (4f)¹ level. In the both levels, only a spin doublet is present, and it is said that the transition between the excited state and the ground state is only the spin tolerance transition. Therefore, likewise Eu²⁺, a luminous efficiency of 100% of the internal quantum efficiency can be expected.

Further, among inorganic compounds, ones in which 100% of an exciton in the triplet excited state intersystem crossing from the singlet excited state contributes to the luminescence are present. In this way, their luminescence route includes many kinds as compared with organic compounds, and therefore, by selecting a suitable inorganic compound in the luminescent layer, it is possible to expect the preparation of devices with higher internal quantum efficiency.

In the case where a combination of EuBr₂ with CsI is used as the inorganic compound, the doping concentration of EuBr₂ against CsI is preferably from 0.01 to 40% by weight, and more preferably from 0.1 to 10% by weight. When the doping concentration is less than 0.01% by weight, the luminescence center density is low and a carrier undergoes luminescence in the hole transport layer or electron transport layer with high possibility, and therefore, such is not preferable. When it exceeds 40% by weight, the concentration quenching is strong and the luminance is remarkably lowered with high possibility, and therefore, such is not preferable.

In the case where a combination of a chloride of a rare earth element with a chloride of an alkali metal is used as the inorganic compound, the thickness of the luminescent layer is preferably from 0.1 to 20 nm, and more preferably from 0.3 to 10 nm. When the thickness of the luminescent layer is less than 0.1 nm, there is some possibility that the carrier penetrates from the hole transition layer into the electron transport layer or reversely penetrates from the electron transport layer into the hole transport layer, thereby causing recombination in other layer than the luminescent layer, and therefore, such is not preferable. When it exceeds 20 nm, there is high possibility that the resistance value increases so that an electric current hardly flows, and therefore, such is not preferable.

Also, in the case where a combination of europium(II) bromide with cesium iodide is used as the inorganic compound, the thickness of the luminescent layer is preferably not more than 5 nm. When it exceeds 5 nm, not only a drive voltage increases but also a luminance is lowered and further, the device is likely damaged, and therefore, such is not preferable.

In the case where a combination of europium(II) bromide with cesium iodide is used as the inorganic compound, it is possible to obtain blue luminescence with high purity of x≦0.16 and y≦0.15 in the CIE 1931 chromaticity coordinates. That is, blue luminescence devices with high color purity equal to or exceeding the chromaticity coordinates (0.15, 0.16) of the luminescence device as described in Non-Patent Document 2 can be obtained.

Examples of the hole block layer include bathocuproine (BCP), triazole derivatives (TAZ), and oxadiazole derivatives. However, it should not be construed that the invention is limited thereto.

Examples of the electron injection layer include lithium fluoride and magnesium fluoride. However, it should not be construed that the invention is limited thereto.

### EXAMPLES

The invention will be hereunder described with reference to the Examples, but it should not be construed that the invention is limited thereto.

### Example 1

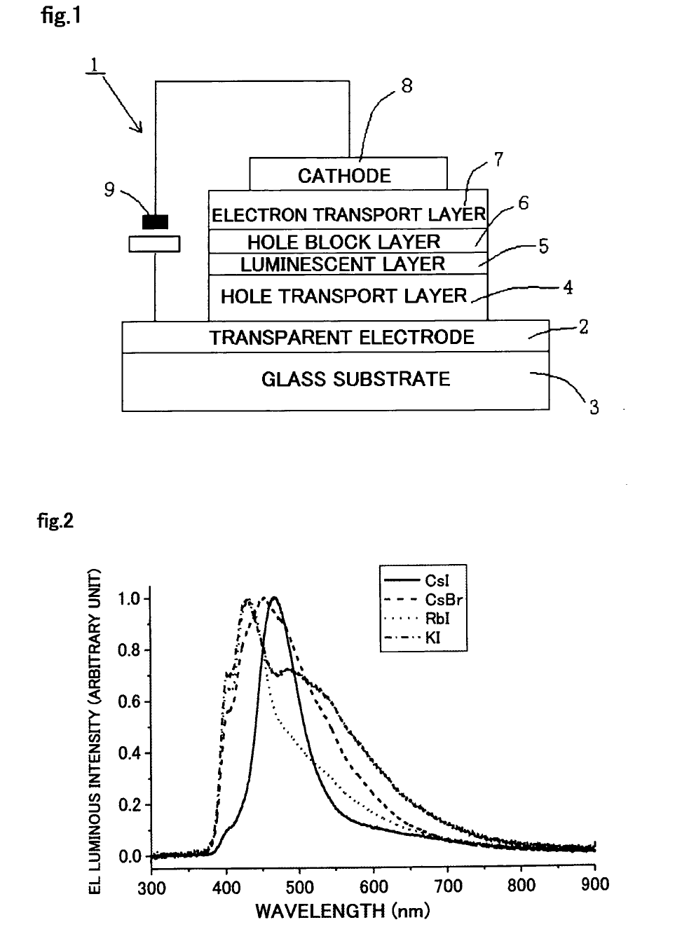

FIG. 1 is an explanatory view to show the device construction of an electroluminescence device according to Example 1 of the invention.

EuBr₂ (europium(II) bromide) which is a halide of a rare earth element and CsI (cesium iodide) which is a halide of an alkali metal were subjected to vapor co-deposition to film form a luminescent layer 5, thereby preparing an electroluminescence device 1, shown in FIG. 1.

Details of the device construction are as follows.

Transparent electrode 2 (ITO)/hole transport layer 4 (TPD)/luminescent layer 5 (CsI+EuBr₂)/hole block layer 6 (BCP)/electron transport layer 7 (Alq₃)/cathode 8 (LiF/Al)

That is, TPD (N,N′-bis(3-methylphenyl)-N,N′-bis(phenyl)-benzidine) was vapor deposited on a glass substrate 3 provided with a transparent electrode 2 (100 nm) constructed of ITO by the vacuum vapor deposition method, thereby forming a hole transport layer 4. The degree of vacuum was 2.0×10⁻⁴ Pa (the same in Examples 2, et seq.), and the film thickness of the hole transport layer 4 was 55 nm.

EuBr₂ and CsI were film formed as a luminescent layer 5 thereon by vapor co-deposition. EuBr₂ was 1% by weight against CsI, and the film thickness of the luminescent layer 5 was 2 nm. The vapor deposition rate was 0.2 ng/cm² sec for CsI and 0.002 ng/cm² sec for europium bromide, respectively.

A hole block layer 6 having a thickness of 25 nm was further formed thereon by vapor deposition using BCP (bathocuproine), and an electron transport layer 7 having a film thickness of 35 nm was further formed by vapor deposition using Alq₃ (tris(8-hydroxyquinoline)aluminum).

Moreover, an LiF—Al electrode was vapor deposited as a cathode in a thickness of 100.7 nm (LiF: 0.7 nm, Al: 100 nm) on the electron transport layer 7, thereby obtaining a cathode 8. In FIG. 1, 9 stands for an electrode.

### Examples 2 to 4

Electroluminescence devices were prepared by film forming a luminescent layer in the same manner as in the foregoing Example 1, except for using RbI (rubidium iodide), KI (potassium iodie) and CsBr (cesium bromide), respectively as the halide of an alkali metal. RbI was used in Example 2, KI was used in Example 3, and CsBr (cesium bromide) was used in Example 4, respectively.

(Measurement of Emission Spectra of Examples 1 to 4)

FIG. 2 shows emission spectra of electroluminescence devices according to Examples 1 to 4.

Incidentally, the emission spectra were measured by a multichannel detector (HAMAMATSU PHOTONICS PMA-11).

As shown in FIG. 2, the luminescence derived from Eu²⁺ from the lowest excited state (4f)⁶(5d)¹ to the ground state (4f)⁷ was observed in each of the Examples.

Also, in Example 1 using CsI as the halide of an alkali metal (host material), 466 nm of an emission peak within the wavelength region exhibiting a blue color and a sharp emission peak having a half value width of 67 nm were obtained, and the CIE 1931 chromaticity coordinates (0.15, 0.11) were obtained. This is blue luminescence with high purity exceeding the CIE 1931 chromaticity coordinates (0.15, 0.16) of the blue luminescence material as reported in Non-Patent Document 2.

The reason why in the case of using CsI, high color purity could be realized is not clear. However, it is estimated that since both a cation (Cs⁺) and an anion (I⁻) of CsI have a large ion radius, EuBr₂ was dissolved as a solid solution in the hexa-coordinated space of the CsI crystal, whereby the strain in the surroundings of Eu²⁺ became small.

(Measurement of Luminance of Example 1)

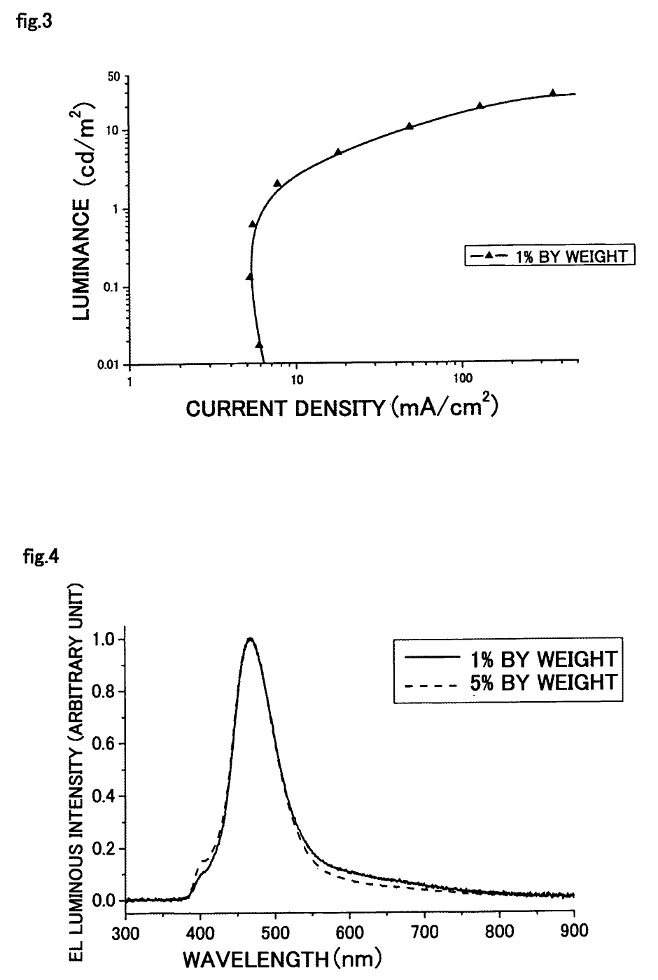

A voltage of 13 V was applied to the electroluminescence device according to Example 1, and its luminance was measured by a luminance meter (MINOLTA LS-110). As a result, the luminance was 25 cd/m². FIG. 3 shows a characteristic graph to show the relationship of luminance-electric current.

### Example 5

A luminescent layer was film formed by changing the doping concentration of EuBr₂ against CsI, and the resulting device was measured with respect to the emission spectrum and luminance.

In detail, an electroluminescence device was prepared in the same manner as in the foregoing Example 1, except that the doping concentration of EuBr₂ against CsI was changed to 5% by weight and designated as Example 5.

(Re: Emission Spectrum)

An emission spectrum of the electroluminescence device according to Example 5 is shown in FIG. 4 along with that of Example 1. Even in Example 5 in which the doping concentration of EuBr₂ is 5% by weight which is five times that in Example 1, its emission spectrum is substantially the same, and the CIE 1931 chromaticity coordinates (0.16, 0.10) were obtained.

(Re: Luminance)

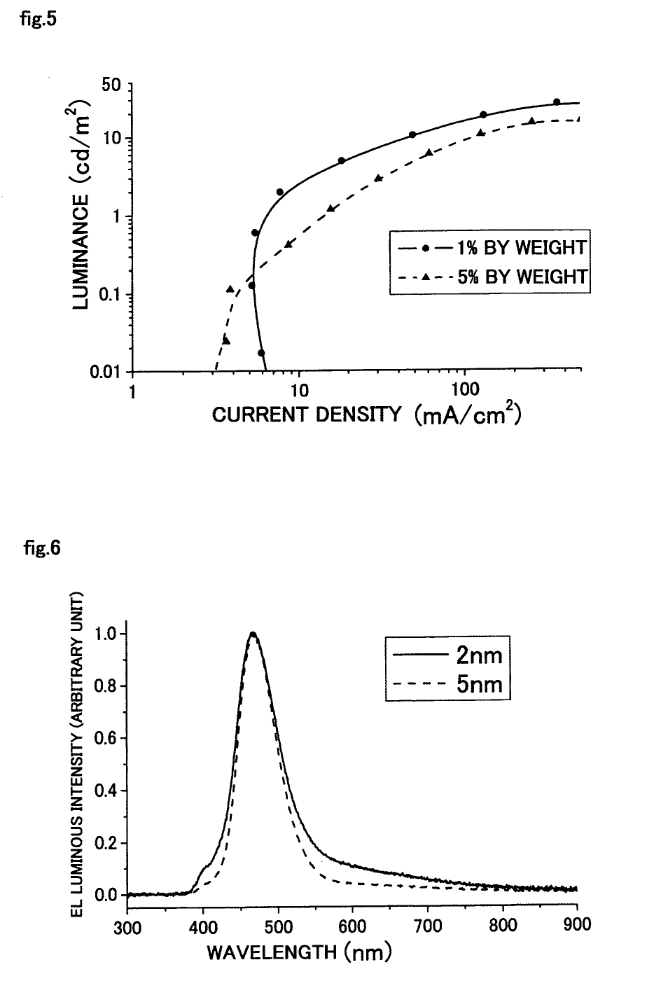

A voltage of 15 V was applied to the electroluminescence device according to Example 5, and its luminance was measured by a luminance meter (MINOLTA LS-110). As a result, the luminance was 15 cd/m². FIG. 5 shows a characteristic graph to show the relationship of luminance-electric current. Incidentally, FIG. 5 also shows the relationship of luminance-electric current of the electroluminescence device according to Example 1 (the doping concentration of EuBr₂ against CsI is 1% by weight).

As shown in FIG. 5, as compared with Example 5 in which the doping concentration of EuBr₂ (5% by % eight) is five times, the luminance against the electric current of Example 1 (1% by weight) is high as about 2.5 times. Accordingly, it is considered that the doping concentration of EuBr₂ is suitably about 1% by weight.

### Example 6

A luminescent layer was film formed by changing the film thickness of the luminescent layer, and an emission spectrum and a luminance of the device were measured.

In detail, an electroluminescence device was prepared in the same manner as in the foregoing Example 1, except that the film thickness of the luminescent layer was changed to 5 nm and designated as Example 6.

(Re: Emission Spectrum)

An emission spectrum of the electroluminescence device according to Example 6 is shown in FIG. 6 along with that of Example 1. As shown in FIG. 6, in Example 6 in which the film thickness of the luminescent layer was 5 nm, the luminescence of its bottom was reduced, and blue luminescence with high purity of the CIE 1931 chromaticity coordinates (0.16, 0.09) was obtained. It is considered that by thickening the luminescent layer, the crystal was grown and defects were reduced.

(Re: Luminance)

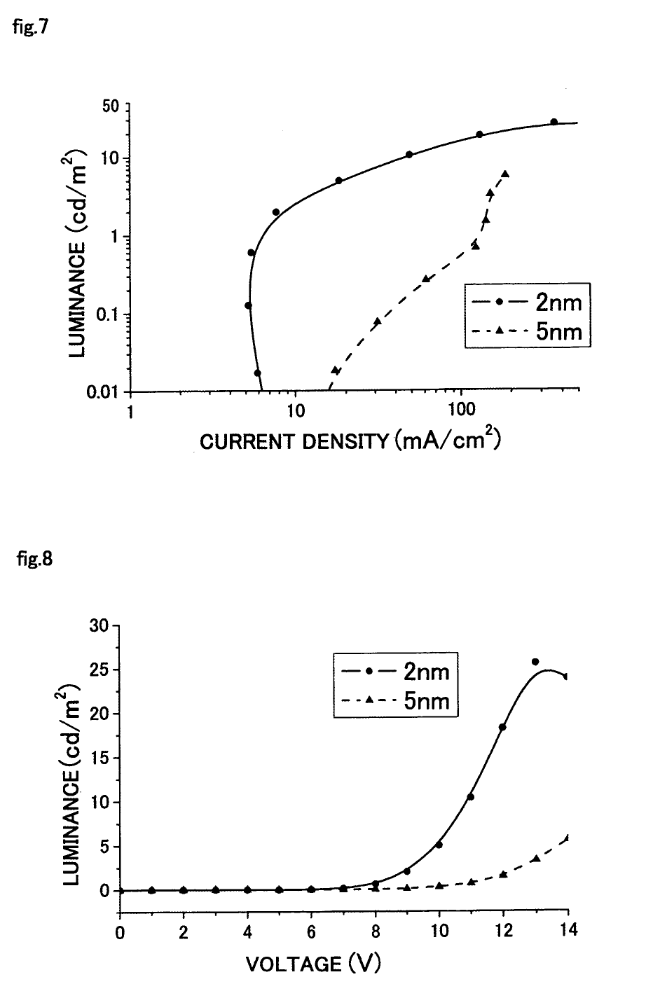

A voltage of 15 V was applied to the electroluminescence device according to Example 6, and its luminance was measured by a luminance meter (MINOLTA LS-110). As a result, the luminance was 5.5 cd/m². FIG. 7 shows a characteristic graph to show the relationship of luminance-electric current. Incidentally, FIG. 7 also shows the relationship of luminance-electric current of the electroluminescence device according to Example 1 (film thickness: 2 nm).

Further, FIG. 8 is a characteristic graph to show the relationship of luminance-voltage of the electroluminescence devices according to Example 1 and Example 6.

As shown in FIG. 7, in Example 6 in which the luminescent layer was thickened to 5 nm, the luminance against the electric current was lowered. With respect to the maximum luminance, it was about 5 cd/m² in Example 6. It is considered that this was caused by the matter that by thickening the luminescent layer, the drive voltage rose.

Incidentally, the terminologies as used in this specification are used for the description purpose to the last but are not limitative, and any terminologies and expressions equivalent to the foregoing terminologies and expressions are never excluded.

### INDUSTRIAL APPLICABILITY

In the light of the above, according to the invention, different from an organic electroluminescence device using an organic compound as a luminescent layer, by using a luminescent layer formed of only an inorganic compound between a hole transport layer and an electron transport layer each formed of an organic compound, a novel charge injection type electroluminescence device which is not influenced by a critical value of an internal quantum efficiency which is considered to be 25% as its upper limit can be formed. In this way, by enhancing the internal quantum efficiency, a novel charge injection type electroluminescence device which can be expected to improve a luminous efficiency can be obtained.

When a combination of a luminescent metal compound with an inorganic compound capable dissolving the metal compound therein as a solid solution is used as the inorganic compound, it is possible to suppress concentration quenching by making a distance between metal ions regarding the luminescence far. As a result, it is possible to enhance a luminous efficiency of the electroluminescence device.

When a metal halide is used as the inorganic compound, since the luminescent layer can be subjected to vapor deposition at a relatively low temperature, there is an advantage that the organic layer is hardly injured by heat.

When a combination of europium(II) bromide with cesium iodide is used as the inorganic compound, it is possible to form a blue luminescence device having high color purity exceeding the CIE 1931 chromaticity coordinates (0.15, 0.16) of the luminescence device as described in Non-Patent Document 2.

1-7. (canceled)

8. A charge injection type electroluminescence device for undergoing luminescence by recombination of a hole to be injected from an anode and an electron to be injected from a cathode, comprising:
a luminescent layer formed of an inorganic compound provided between a hole transport layer and an electron transport layer, each formed of an organic compound.

9. The electroluminescence device according to claim 8, wherein the inorganic compound is provided with a metal compound which undergoes luminescence by luminescent transition by spin tolerance transition or spin inhibition transition, or undergoes luminescence by luminescent transition by inner-shell transition of a metal ion.

10. The electroluminescence device according to claim 8, wherein the inorganic compound is a combination of a luminescent metal compound with an inorganic compound capable dissolving the metal compound therein as a solid solution.

11. The electroluminescence device according to claim 9, wherein the inorganic compound is a combination of a luminescent metal compound with an inorganic compound capable dissolving the metal compound therein as a solid solution.

12. The electroluminescence device according to claim 8, wherein the inorganic compound is a metal halide.

13. The electroluminescence device according to claim 9, wherein the inorganic compound is a metal halide.

14. The electroluminescence device according to claim 10, wherein the inorganic compound is a metal halide.

15. The electroluminescence device according to claim 11, wherein the inorganic compound is a metal halide.

16. The electroluminescence device according to claim 8, wherein the inorganic compound is a combination of a halide of a rare earth element with a halide of an alkali metal or an alkaline earth metal.

17. The electroluminescence device according to claim 9, wherein the inorganic compound is a combination of a halide of a rare earth element with a halide of an alkali metal or an alkaline earth metal.

18. The electroluminescence device according to claim 10, wherein the inorganic compound is a combination of a halide of a rare earth element with a halide of an alkali metal or an alkaline earth metal.

19. The electroluminescence device according to claim 11, wherein the inorganic compound is a combination of a halide of a rare earth element with a halide of an alkali metal or an alkaline earth metal.

20. The electroluminescence device according to claim 8, wherein the inorganic compound is a combination of a halide of divalent europium with a halide of an alkali metal or an alkaline earth metal.

21. The electroluminescence device according to claim 9, wherein the inorganic compound is a combination of a halide of divalent europium with a halide of an alkali metal or an alkaline earth metal.

22. The electroluminescence device according to claim 10, wherein the inorganic compound is a combination of a halide of divalent europium with a halide of an alkali metal or an alkaline earth metal.

23. The electroluminescence device according to claim 11, wherein the inorganic compound is a combination of a halide of divalent europium with a halide of an alkali metal or an alkaline earth metal.

24. The electroluminescence device according to claim 8, wherein the inorganic compound is a combination of europium(II) bromide with cesium iodide.

25. The electroluminescence device according to claim 9, wherein the inorganic compound is a combination of europium(II) bromide with cesium iodide.

26. The electroluminescence device according to claim 10, wherein the inorganic compound is a combination of europium(II) bromide with cesium iodide.

27. The electroluminescence device according to claim 11, wherein the inorganic compound is a combination of europium(II) bromide with cesium iodide.
